(19) United States
(12) Patent Application Publication
(10) Pub. No.: US 2026/0152169 A1
(43) Pub. Date: Jun. 4, 2026

(54) SYSTEM, METHOD, AND STORAGE MEDIUM FOR CONTROLLING A HYBRID ELECTRIC VEHICLE

(71) Applicants: HYUNDAI MOTOR COMPANY, Seoul (KR); KIA CORPORATION, Seoul (KR)

(72) Inventors: Ick Hwan Kim, Hwaseong-si (KR); Sang Hyeok Mo, Hwaseong-si (KR)

(73) Assignees: HYUNDAI MOTOR COMPANY, Seoul (KR); KIA CORPORATION, Seoul (KR)

(21) Appl. No.: 19/209,425

(22) Filed: May 15, 2025

(30) Foreign Application Priority Data
Nov. 29, 2024 (KR) 10-2024-0174514

(51) Int. Cl. B60W 20/13; B60W 10/06; B60W 10/08; B60W 20/20

(52) U.S. Cl. CPC B60W 20/13; B60W 10/06; B60W 10/08; B60W 20/20; B60W 2300/18; B60W 2510/244; B60W 2520/10; B60W 2540/10; B60W 2710/065; B60W 2710/0666; B60W 2710/083

(57) ABSTRACT

A system for controlling a hybrid electric vehicle including a pair of front wheels and a pair of rear wheels includes a first motor configured to provide torque to one of the pair of front wheels and the pair of rear wheels; a second motor configured to provide torque to the remaining pair of wheels; an engine configured to provide torque to the remaining pair of wheels of the hybrid electric vehicle; a battery configured to provide energy to the second motor; and a controller configured to control the engine or the second motor to provide the torque to the remaining pair of wheels when a speed of the hybrid electric vehicle is greater than a predetermined speed value or a state of charge (SOC) of the battery is greater than a predetermined SOC value.

### CROSS-REFERENCE TO RELATED APPLICATION

This application claims benefit of and priority to Korean Patent Application No. 10-2024-0174514 filed on Nov. 29, 2024 in the Korean Intellectual Property Office, the entire contents of which are incorporated herein by reference in its entirety.

### TECHNICAL FIELD

The present disclosure relates to a system, a method and a storage medium for controlling a hybrid electric vehicle.

### BACKGROUND

Generally, technology for increasing the fuel efficiency of vehicles by using an engine and a motor has been applied to hybrid electric vehicles (HEVs). In order to increase fuel efficiency, the HEVs turn off the engine in the case of a low-load operation and drive in an electric vehicle (EV) mode by using an electric motor. If the driver steps on the accelerator pedal to accelerate while driving the HEV in the EV mode and a driving demand load increases, the HEV turns on the engine and accelerates in an HEV mode using the motor and the engine. The subject matter described in this background section is intended to promote an understanding of the background of the disclosure and thus may include subject matter that is not already known to those of ordinary skill in the art. The statements in this section merely provide background information related to the present disclosure and may not constitute prior art.

### SUMMARY

An aspect of the present disclosure aims to provide a system and a method for controlling a hybrid electric vehicle. The system and the method may stably prevent a decrease/interruption of torque providing performance of a motor due to an excessively low state of charge of a battery. The system and the method may reduce engagement shock during an engagement process between an engine and a motor (e.g., engagement shock due to a difference in revolutions per minute (RPM) between the engine and the motor). The system and the method may charge the motor with higher charging efficiency than charging efficiency of a method in which the engine charges the battery through only a hybrid starter generator.

According to an aspect of the present disclosure, a system for controlling a hybrid electric vehicle including a pair of front wheels and a pair of rear wheels includes a first motor configured to provide torque to one of the pair of front wheels and the pair of rear wheels of the hybrid electric vehicle. The system further includes a second motor configured to provide torque to the remaining pair of wheels, among the pair of front wheels and the pair of rear wheels, not driven by the first motor, of the hybrid electric vehicle. The system further includes an engine configured to provide torque to the remaining pair of the wheels of the hybrid electric vehicle. The system further includes a battery configured to provide energy to the second motor. The system further includes a controller configured to control at least one of the engine or the second motor to provide the torque to the remaining pair of wheels when a speed of the hybrid electric vehicle is greater than a predetermined speed value or a state of charge (SOC) of the battery is greater than a predetermined SOC value. The controller is further configured to control the first motor to provide the torque to the one of the pair of front wheels and the pair of rear wheels to charge the battery through the second motor when the speed of the hybrid electric vehicle is equal to or less than the predetermined speed value and the SOC of the battery is equal to or less than the predetermined SOC value.

The controller may control the engine to provide the torque to the remaining pair of wheels when the speed of the hybrid electric vehicle is greater than the predetermined speed value. The controller may control the second motor to provide the torque to the remaining pair of wheels when the speed of the hybrid electric vehicle is equal to or less than the predetermined speed value and the SOC of the battery is greater than the predetermined SOC value.

The controller may control two-wheel driving through the engine or four-wheel driving through the engine and the first motor when the speed of the hybrid electric vehicle is greater than the predetermined speed value.

The controller may control two-wheel driving through the torque provided by the first motor when the speed of the hybrid electric vehicle is equal to or less than the predetermined speed value and the SOC of the battery is equal to or less than the predetermined SOC value. The controller may control two-wheel driving through the second motor or four-wheel driving through the first and second motors when the speed of the hybrid electric vehicle is equal to or less than the predetermined speed value and the SOC of the battery is greater than the predetermined SOC value.

The controller may control the engine to be engaged with the second motor when the speed of the hybrid electric vehicle is greater than the predetermined speed value. The controller may control the engine to be separated from the second motor when the speed of the hybrid electric vehicle is equal to or less than the predetermined speed value.

The controller may control the engine to be engaged with the second motor when a revolutions per minute (RPM) of the remaining pair of wheels of the hybrid electric vehicle reaches an engagement condition RPM. The controller may receive a sensing value from an accelerator pedal sensor. The controller may selectively adjust the engagement condition RPM according to the sensing value.

The controller may receive corresponding data between the sensing value and a charge torque. The controller may selectively increase the engagement condition RPM according to a relationship between the charge torque determined according to the sensing value and the corresponding data and a maximum torque corresponding to idling of the engine.

The controller may control the engine to be engaged with the second motor when a revolutions per minute (RPM) of the remaining pair of wheels of the hybrid electric vehicle reaches an idle RPM of the engine. The controller may receive a sensing value from an accelerator pedal sensor. The controller may selectively increase the idle RPM according to the sensing value.

The second motor may generate power and charge the battery according to a charge torque generated according to rotations of the front wheel and the rear wheel of the hybrid electric vehicle by the torque provided from the first motor when the speed of the hybrid electric vehicle is equal to or less than the predetermined speed value and the SOC of the battery is equal to or less than the predetermined SOC value.

The first motor may provide torque to the rear wheel, and the second motor and the engine may provide torque to the front wheel.

According to another aspect of the present disclosure, a system for controlling a hybrid electric vehicle includes a first motor configured to provide torque to a rear wheel of a hybrid electric vehicle. The system further includes a second motor configured to provide torque to a front wheel of the hybrid electric vehicle. The system further includes an engine configured to provide torque to the front wheel of the hybrid electric vehicle. The system further includes a battery configured to provide energy to the second motor. The system further includes a controller configured to control the hybrid electric vehicle to four-wheel driving or front-wheel driving when a speed of the hybrid electric vehicle is greater than a predetermined speed value or a state of charge (SOC) of the battery is greater than the predetermined SOC value. The controller is further configured to control the hybrid electric vehicle to rear-wheel driving when the speed of the hybrid electric vehicle is equal to or less than the predetermined speed value and the SOC of the battery is equal to or less than the predetermined SOC value.

The controller may control the engine to be engaged with the second motor when the speed of the hybrid electric vehicle is greater than the predetermined speed value. The controller may control the engine to be separated from the second motor when the speed of the hybrid electric vehicle is equal to or less than the predetermined speed value.

The controller may control the engine to be engaged with the second motor when a revolutions per minute (RPM) of the front wheel reaches an engagement condition RPM. The controller may receive a sensing value from an accelerator pedal sensor. The controller may selectively adjust the engagement condition RPM according to the sensing value.

The controller may control the engine to be engaged with the second motor when a revolutions per minute (RPM) of the front wheel reaches an idle RPM of the engine. The controller may receive a sensing value from an accelerator pedal sensor. The controller may selectively increase the idle RPM according to the sensing value.

The controller may control two-wheel driving through the torque provided by the first motor when the speed of the hybrid electric vehicle is equal to or less than the predetermined speed value and the SOC of the battery is equal to or less than the predetermined SOC value. The controller may control two-wheel driving through the second motor or four-wheel driving through the first and second motors when the speed of the hybrid electric vehicle is equal to or less than the predetermined speed value and the SOC of the battery is greater than the predetermined SOC value.

According to another aspect of the present disclosure, a method for controlling a hybrid electric vehicle including a pair of front wheels and a pair of rear wheels includes obtaining a speed of the hybrid electric vehicle and a state of charge (SOC) of a battery of the hybrid electric vehicle. The method further includes determining whether a plurality of conditions is satisfied. The method further includes controlling, when a first condition among the plurality of conditions is satisfied, a first motor of the hybrid electric vehicle to provide torque to one of the pair of front wheels and the pair of rear wheels of the hybrid electric vehicle according to the first condition to charge the battery through a second motor of the hybrid electric vehicle. The method further includes controlling, when a second condition among the plurality of conditions is satisfied, the second motor to provide torque to the remaining pair of wheels, among the pair of front wheels and the pair of rear wheels, not driven by the first motor, of the hybrid electric vehicle according to the second condition. The method further includes controlling, when a third condition among the plurality of conditions is satisfied, an engine of the hybrid electric vehicle to provide torque to the remaining pair of wheels of the hybrid electric vehicle according to the third condition. The first condition is that the speed of the hybrid electric vehicle is equal to or less than the predetermined speed value and the SOC of the battery is equal to or less than a predetermined SOC value. The second condition is that the speed of the hybrid electric vehicle is equal to or less than the predetermined speed value and the SOC of the battery is greater than the predetermined SOC value. The third condition is that the speed of the hybrid electric vehicle is greater than the predetermined speed value.

Controlling according to the first condition may include controlling two-wheel driving through the torque provided by the first motor. Controlling according to the second condition may include controlling two-wheel driving through the second motor or four-wheel driving through the first and second motors. Controlling according to the third condition may include controlling two-wheel driving through the engine or four-wheel driving through the engine and the first motor.

Controlling according to the third condition may include controlling the engine to be engaged with the second motor when a revolutions per minute (RPM) of the remaining pair of wheels of the hybrid electric vehicle reaches an engagement condition RPM. Controlling according to the third condition may include receiving a sensing value from an accelerator pedal sensor. Controlling according to the third condition may include selectively adjusting the engagement condition RPM according to the sensing value.

Controlling according to the third condition may include controlling the engine to be engaged with the second motor when a revolutions per minute (RPM) of the remaining pair of wheels of the hybrid electric vehicle reaches an idle RPM of the engine. Controlling according to the third condition may include receiving a sensing value from an accelerator pedal sensor. Controlling according to the third condition may include selectively increasing the idle RPM according to the sensing value.

According to another aspect of the present disclosure, a non-transitory storage medium may record one or more programs including commands for executing the method for controlling the hybrid electric vehicle thereon.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a diagram illustrating a system for controlling a hybrid electric vehicle according to an embodiment of the present disclosure;

FIG. 2 is a diagram illustrating a control difference according to a plurality of conditions of a system and a method for controlling a hybrid electric vehicle according to an embodiment of the present disclosure;

FIG. 3 is a graph illustrating motor/engine torque over time in the case of low state of charge (SOC) in a system and a method for controlling a hybrid electric vehicle according to an embodiment of the present disclosure;

FIG. 4 is a flowchart illustrating a system and a method for controlling a hybrid electric vehicle according to an embodiment of the present disclosure;

FIG. 5 is a flowchart illustrating an operation of adjusting an engagement condition revolution per minute (RPM) (or engine idle RPM) between an engine and a second motor according to an accelerator pedal sensor sensing value in a system and a method for controlling a hybrid electric vehicle according to an embodiment of the present disclosure;

FIG. 6 is an engine performance curve representing adjustment of an engagement condition RPM (or engine idle RPM) between an engine and a second motor according to an accelerator pedal sensor sensing value in a system and a method for controlling a hybrid electric vehicle according to an embodiment of the present disclosure; and

FIG. 7 is a block diagram illustrating a controller, implemented as a computing device, of a system for controlling a hybrid electric vehicle according to an embodiment of the present disclosure.

### DETAILED DESCRIPTION

While the present disclosure may be modified in various ways and take on various alternative forms, specific embodiments thereof are shown in the drawings and described in detail below. However, it should be understood that the embodiments are not intended to limit the present disclosure to the particular forms disclosed. On the contrary, the present disclosure covers all modifications, equivalents, and alternatives falling within the spirit and scope of the present disclosure.

It should be understood that, although the terms “first,” “second,” etc. may be used herein to describe various elements, these elements should not be limited by these terms. These terms are only used to distinguish one element from another. For example, a first element could be termed as a second element, and a second element could similarly be termed as a first element without departing from the scope of the present disclosure. As used herein, the term “and/or” includes any and all combinations of one or more of the associated listed items.

The terms used herein to describe embodiments of the present disclosure are not intended to limit the scope of the present disclosure. The articles “a,” and “an” may indicate a singular form. However, the use of the singular form in the present disclosure should not preclude the plural form. In other words, elements of the present disclosure in the singular form may be in the plural form, unless the context clearly indicates otherwise. It should be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different way, all the terms used herein including technical and scientific terms have the same meanings as understood by those having ordinary skill in the art to which the present disclosure pertains. Such terms as defined in generally used dictionaries should be construed to have the same meanings as those of the contexts of the related art. Unless clearly defined in the present disclosure, the terms should not be construed to have ideally or excessively formal meanings.

In the present disclosure, vehicles refer to a variety of vehicles that move transported objects, such as people, animals, or goods, from a starting point to a destination. These vehicles are not limited to vehicles that run on roads or tracks. When a controller, apparatus, module, component, device, element, or the like of the present disclosure is described as having a purpose or performing an operation, function, or the like, the controller, apparatus, module, component, device, element, or the like should be considered herein as being “configured to” meet that purpose or to perform that operation or function. Each controller, apparatus, module, component, device, element, and the like may separately embody or be included with a processor and a memory, such as a non-transitory computer readable media, as part of the apparatus.

Hereinafter, embodiments of the present disclosure are described with reference to the accompanying drawings.

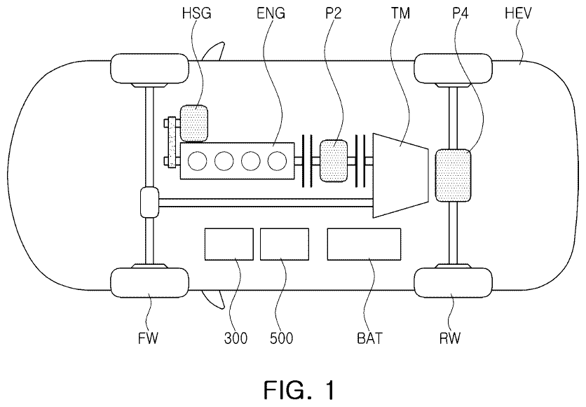

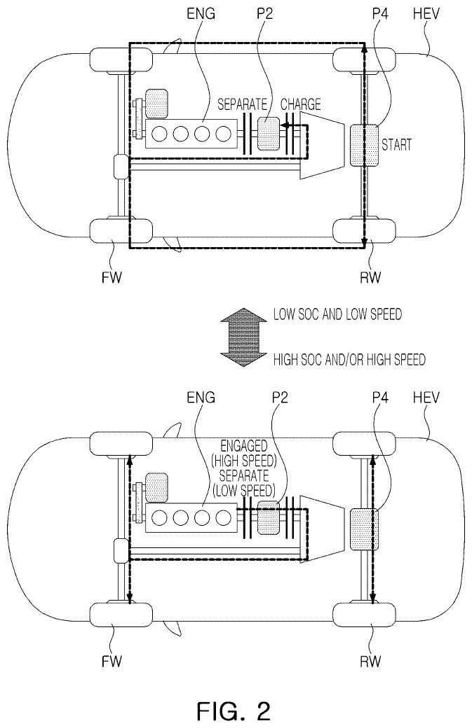

Referring to FIGS. 1 and 2, a system for controlling a hybrid electric vehicle according to an embodiment of the present disclosure may include a first motor P4, a second motor P2, an engine ENG, a battery BAT, and a controller 500. The system for controlling the hybrid electric vehicle may be a hybrid electric vehicle HEV or may be disposed in a hybrid electric vehicle HEV. The upper portion of FIG. 2 represents a first condition among a plurality of conditions of the hybrid electric vehicle HEV of FIG. 1, and the lower portion of FIG. 2 represents a second condition (separation) and a third condition (engagement) among a plurality of conditions of the hybrid electric vehicle HEV.

The first motor P4 may provide torque to one (e.g., a rear wheel) of a front wheel FW and a rear wheel RW of a hybrid electric vehicle HEV. For example, the first motor P4 may be connected to a power shaft of the rear wheel RW, may be inclined rearwardly from the center of the hybrid electric vehicle HEV, and may be disposed closer to the rear wheel RW than the front wheel FW.

The second motor P2 may provide torque to the other (e.g., the front wheel) of the front wheel FW and the rear wheel RW of the hybrid electric vehicle HEV. For example, the second motor P2 may be disposed between the engine ENG and a transmission TM and may be permanently engaged with the transmission TM to provide torque to the front wheel FW through the transmission TM. The second motor P2 may be connected to a gear input shaft of the hybrid electric vehicle HEV, but is not limited thereto.

For example, each of the first and second motors P4 and P2 may be implemented as an induction motor or a permanent magnet synchronous motor. Each of the first and second motors P4 and P2 may further include a power converter (e.g., an inverter and/or a rectifier) converting between direct current (DC) and alternating current (AC). Each of the first and second motors P4 and P2 may further include a motor controller controlling the operation of the power converter (e.g., ON/OFF operation of a plurality of switches constituting the power converter). Based on the design, the motor controller may be implemented as at least a part of the controller 500.

The hybrid electric vehicle HEV may be configured so that the torques provided by the first and second motors P4 and P2 are independent of each other (e.g., not connected between the power shaft of the rear wheel and the transmission TM). For example, the motor controller and/or controller 500 may consider a torque relationship (e.g., torque distribution, etc.) between the first and second motors P4 and P2 in the process of determining the torque of each of the first and second motors P4 and P2 (e.g., calculating the torque value according to a control logic). However, the first and second motors P4 and P2 may independently provide the determined torque to the rear wheel RW and the front wheel FW, respectively. Accordingly, the first and second motors P4 and P2 may selectively provide one selected from among rear-wheel driving of driving only the rear wheel RW, front-wheel driving of driving only the front wheel FW, and four-wheel driving of driving both the rear wheel RW and the front wheel FW, based on the situation/state of the hybrid electric vehicle HEV.

The engine ENG may provide torque to the other (e.g., the front wheel) of the front wheel FW and the rear wheel RW of the hybrid electric vehicle HEV. For example, the engine ENG may provide torque only to the front wheel FW of the hybrid electric vehicle HEV, and the structure for providing torque to the rear wheel RW (e.g., a driving shaft connected between the front wheel FW and the rear wheel RW) may be omitted.

The first and second motors P4 and P2 may efficiently provide torque when the speed of the hybrid electric vehicle HEV is low, and the engine ENG may efficiently provide torque when the speed of the hybrid electric vehicle HEV is high (e.g., greater than a predetermined speed value). Therefore, the hybrid electric vehicle HEV may have both the advantages of the engine ENG efficient at a high speed stage and the advantages of the first and second motors P4 and P2 efficient at a low speed stage (e.g., equal to or less than the predetermined speed value). Alternatively, because the hybrid electric vehicle HEV may use both a fuel supply source used by the engine ENG and an electric energy supply source used by the first and second motors P4 and P2, the hybrid electric vehicle HEV may also be advantageous in improving the stability/efficiency of energy supply.

The battery BAT may provide energy to the second motor P2. For example, the battery BAT may output DC power to a power converter (e.g., an inverter) of the second motor P2. When the second motor P2 performs regenerative braking, energy generated through the second motor P2 may be converted into DC power by the power converter (e.g., a rectifier) and charged to the battery BAT.

For example, the battery BAT may include a battery management system (BMS). The battery management system may monitor at least one of current, voltage, or temperature of the battery BAT, may generate charging status data based on a monitoring result, and may transmit the charging status data to the controller 500. Accordingly, the controller 500 may know the charging status of the battery BAT. Based on the design, at least a part of the battery management system may be included in the controller 500.

For example, the battery BAT may have a structure in which a portion charged or discharged through the second motor P2 and a portion charged or discharged through the first motor P4 are independent of each other (e.g., a structure in which the portions are separated from each other and placed at the front and rear of the hybrid electric vehicle). Here, a state of charge (SOC) of the battery BAT refers to at least the state of charge of the portion of the battery BAT charged or discharged through the second motor P2. For example, the battery BAT may be implemented as a high-voltage battery (e.g., a rated voltage of 300 V to 400 V) and may be implemented as one or more battery packs. Alternatively, the hybrid electric vehicle HEV may further include a separate battery for charging and discharging the first motor P4.

The controller 500 may control at least one of the engine ENG or the second motor P2 to provide torque to the other one (e.g., the front wheel) of the front wheel FW and the rear wheel RW when the speed of the hybrid electric vehicle HEV corresponds to high speed or the state of charge of the battery BAT corresponds to high SOC (e.g., greater than a predetermined SOC value) (the second condition or the third condition). For example, the controller 500 may be implemented as an electronic control unit (ECU), but is not limited thereto.

For example, the controller 500 may control the second motor P2 or the engine ENG by determining a torque value to be provided by the engine ENG or the second motor P2 and transmitting a control signal corresponding to the torque value to the ECU of the engine ENG or transmitting a current command signal corresponding to the torque value to the second motor P2.

As the state of charge (SOC) of the battery BAT decreases, the torque provision of the second motor P2 may be temporarily weakened or stopped. A criterion for determining whether the state of charge of the battery BAT is a low SOC (e.g., equal to or less than the predetermined SOC value) or a high SOC is not particularly limited. Instead, the criterion may be set to a state of charge at which the torque providing performance of the second motor P2 begins to effectively deteriorate and may be optimized according to the total capacity of the battery BAT. For example, herein, a medium SOC between the low SOC and the high SOC is not defined, but the medium SOC may belong to the high SOC.

If the state of charge of the battery BAT becomes too low (e.g., completely discharged) and the engine ENG urgently provides torque to the front wheel FW instead of the second motor P2, the engine ENG may cause engagement shock (e.g., engagement shock due to a significant difference in (RPM between the engine and the second motor) during the process in which the engine ENG is urgently engaged with the second motor P2. The engagement shock may damage the structure (e.g., a clutch and a surrounding structure thereof) of engaging the engine ENG with the second motor P2.

Therefore, the state of charge of the battery BAT needs to be managed so as not to become too low. Meanwhile, the method in which the engine ENG charges the battery BAT through only the hybrid starter generator (HSG) may be a method difficult to secure charging efficiency.

The controller 500 may control the first motor P4 to provide torque to one (e.g., the rear wheel) of the front wheel FW and the rear wheel RW to charge the battery BAT through the second motor P2 when the speed of the hybrid electric vehicle HEV is low (including stopping) and the state of charge of the battery BAT corresponds to a low SOC (first condition). For example, the controller 500 may control (e.g., driving control, driving start control) the first motor P4 by determining a torque value to be provided by the first motor P4 and transmitting a current command signal corresponding to the torque value to the first motor P4.

Accordingly, the system for controlling the hybrid electric vehicle according to an embodiment of the present disclosure may stably prevent the torque providing performance deterioration/interruption of the second motor P2 due to an excessively low state of charge of the battery BAT. The system may reduce engagement shock (e.g., engagement shock due to a significant difference in RPM between the engine and the second motor) during the engagement process between the engine ENG and the second motor P2. The system may charge the second motor P2 with a higher charging efficiency than the charging efficiency of the method in which the engine ENG charges the battery BAT through only the hybrid starter generator (HSG).

For example, the second motor P2 may generate power and charge the battery BAT according to charge torque generated according to the rotation of the front wheel FW and rear wheel RW of the hybrid electric vehicle HEV by the torque provided from the first motor P4 when the speed of the hybrid electric vehicle HEV is low (including stopping) and the state of charge of the battery BAT corresponds to a low SOC (the first condition). For example, the first motor P4 may receive energy (DC power) from a portion separated from the portion of the battery BAT charged or discharged through the second motor P2 or may receive energy from a separate battery for charging and discharging the first motor P4.

For example, the system for controlling the hybrid electric vehicle according to an embodiment of the present disclosure may further include the sensor unit 300. The sensor unit 300 may include at least one of a vehicle speed sensor (e.g., a longitudinal vehicle speed sensor and/or a lateral vehicle speed sensor) sensing the speed of the hybrid electric vehicle HEV, a wheel speed sensor sensing a wheel speed of each of the front wheel FW and the rear wheel RW, or an accelerator pedal sensor (APS) sensing input of an accelerator pedal. The controller 500 may receive a sensing value (e.g., a sensing value of the vehicle speed sensor) from the sensor unit 300 and may know the speed of the hybrid electric vehicle HEV based on the sensing value.

The controller 500 may control the engine ENG to be engaged with the second motor P2 when the speed of the hybrid electric vehicle HEV corresponds to a high speed (the third condition). The controller 500 may control the engine ENG to be separated from the second motor P2 (the first condition or the second condition) when the speed of the hybrid electric vehicle HEV corresponds to a low speed (including stopping). The criterion for determining whether the speed of the hybrid electric vehicle HEV is a low speed or a high speed is not particularly limited but may be set as a turning point of the relationship between the RPM of the front wheel FW corresponding to the speed and an idle RPM (e.g., 1000 rpm to 1500 rpm) of the engine ENG. This is because as the difference between the RPM of the front wheel FW and the idle RPM of the engine ENG decreases, engagement shock during the engagement process between the engine ENG and the second motor P2 may decrease.

For example, the controller 500 may control the engine ENG to provide torque to the other (e.g., the front wheel) of the front wheel FW and the rear wheel RW when the speed of the hybrid electric vehicle HEV corresponds to a high speed (the third condition). The controller 500 may control the second motor P2 to provide torque to the other (e.g., the front wheel) of the front wheel FW and the rear wheel RW when the speed of the hybrid electric vehicle HEV corresponds to a low speed (including stopping) and the state of charge of the battery BAT corresponds to a high SOC (the second condition).

Accordingly, when the speed of the hybrid electric vehicle HEV is low, which of the first and second motors P4 and P2 to use may be determined according to the state of charge of the battery BAT. Accordingly, the first and second motors P4 and P2 may be used in a balanced manner, and the torque providing performance of the first motor P4 may be prevented from being degraded or stopped.

For example, the controller 500 may control two-wheel driving through the engine ENG or four-wheel driving through the engine ENG and the first motor P4 when the speed of the hybrid electric vehicle HEV corresponds to a high speed (the third condition). For example, the controller 500 may secure the stability of the hybrid electric vehicle HEV by controlling the four-wheel driving when the hybrid electric vehicle HEV drives in an area with a low road friction coefficient or when a steering angle increases. The controller 500 may improve the energy efficiency of the hybrid electric vehicle HEV by controlling two-wheel driving when the hybrid electric vehicle HEV drives in an area with a high road friction coefficient or when driving straight. For example, the controller 500 may control the distribution between the torque value to be provided by the first motor P4 and the torque value to be provided by the second motor P2 when controlling four-wheel driving (e.g., using vehicle dynamic control (VDC) and/or traction control system (TCS)).

The controller 500 may control the hybrid electric vehicle HEV as four-wheel driving or front-wheel driving when the speed of the hybrid electric vehicle HEV corresponds to a high speed or when the state of charge of the battery BAT corresponds to a high SOC (the second condition or the third condition). The controller 500 may control the hybrid electric vehicle HEV as rear-wheel driving when the speed of the hybrid electric vehicle HEV corresponds to a low speed (including stopping) and the state of charge of the battery BAT corresponds to a low SOC (the first condition). Accordingly, the system for controlling the hybrid electric vehicle according to an embodiment of the present disclosure may reduce the engagement shock (e.g., engagement shock due to a significant difference in RPM between the engine and the second motor) during the engagement process between the engine ENG and the second motor P2. The system may prevent damage to the structure (e.g., the clutch and a surrounding structure thereof) of engaging between the engine ENG and the second motor P2.

The controller 500 may control two-wheel driving through torque provided by the first motor P4 when the speed of the hybrid electric vehicle HEV is low (including stopping) and the state of charge of the battery BAT corresponds to low SOC (the first condition). The controller 500 may control two-wheel driving through the second motor P2 or four-wheel driving through the first and second motors P4 and P2 when the speed of the hybrid electric vehicle HEV is low (including stopping) and the state of charge of the battery BAT corresponds to a high SOC (the second condition). Accordingly, when the speed of the hybrid electric vehicle HEV is low, which of the first and second motors P4 and P2 to use may be determined according to the state of charge of the battery BAT. Thus, the first and second motors P4 and P2 may be used in a balanced manner and the torque providing performance of the first and second motors P4 and P2 may be prevented from being deteriorated or interrupted.

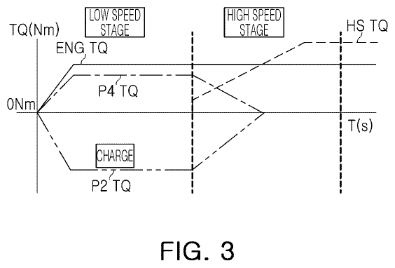

FIG. 3 is a graph illustrating motor/engine torque over time (unit: second) in the case of a low state of charge (SOC) in a system and a method for controlling a hybrid electric vehicle according to an embodiment of the present disclosure. FIG. 3 illustrates a situation in which the hybrid electric vehicle gradually increases the speed from a stationary state. A low-speed stage of FIG. 3 may correspond to the first condition, and a high-speed stage of FIG. 3 may correspond to the third condition.

Referring to FIGS. 1 and 3, in the low-speed stage (corresponding to the first condition), the first motor P4 may start and provide torque P4 TQ rising to a specific value to the rear wheel RW, and the second motor P2 may receive greater torque P2 TQ as charge torque as the torque P4 TQ of the first motor P4 increases. At this time, the engine ENG may also generate inactive torque ENG TQ but may not be engaged with the second motor P2.

In the high-speed stage (corresponding to the third condition), the engine ENG may be engaged with the second motor P2 and may provide a gradually increasing active torque HS TQ to the front wheel FW. At this time, the torque P4 TQ and P2 TQ of the first and second motors P4 and P2 may gradually decrease.

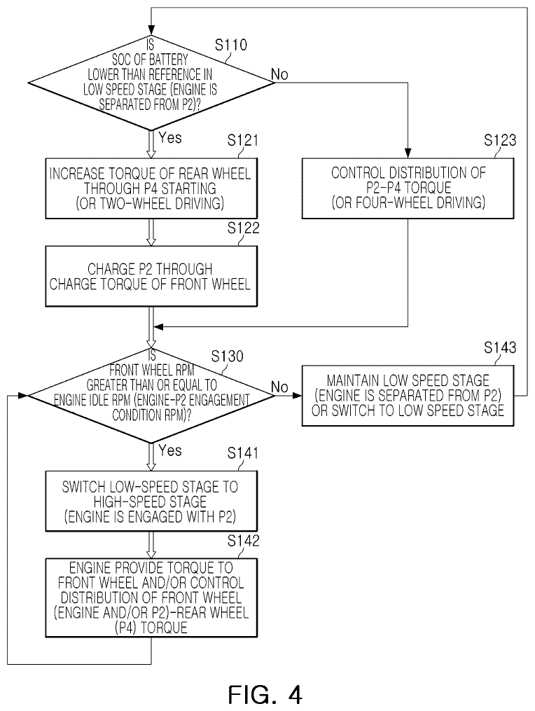

Referring to FIGS. 1 and 4, a method for controlling a hybrid electric vehicle according to an embodiment of the present disclosure may include operations S110 and S130 of obtaining, by the controller 500, a speed of the hybrid electric vehicle HEV and a state of charge of the battery BAT of the hybrid electric vehicle HEV and determining whether a plurality of conditions is satisfied. The method may include operations S121 and S122 of providing torque to one (e.g., the rear wheel) of the front wheel FW and the rear wheel RW to charge the battery BAT through the second motor P2 when the first condition among the plurality of conditions is satisfied. The method may include operation S123 of controlling the second motor P2 according to the second condition to provide torque to the other (e.g., the front wheel) among the front wheel FW and the rear wheel RW when the second condition among the plurality of conditions is satisfied. The method may include operation S142 of controlling the engine ENG according to the third condition to provide torque to the other (e.g., the front wheel) among the front wheel FW and the rear wheel R2 when the third condition among the plurality of conditions is satisfied. The first condition may be that the speed of the hybrid electric vehicle HEV is low (including stopping) and the state of charge of the battery BAT corresponds to a low SOC. The second condition may be that the speed of the hybrid electric vehicle HEV is low (including stopping) and the state of charge of the battery BAT corresponds to a high SOC. The third condition may be that the speed of the hybrid electric vehicle HEV corresponds to a high speed.

Accordingly, the method for controlling the hybrid electric vehicle according to an embodiment of the present disclosure may stably prevent a decrease/interruption of torque providing performance of the second motor P2 due to an excessively low state of charge of the battery BAT. The method may reduce engagement shock during an engagement process between the engine ENG and the second motor P2 (e.g., engagement shock due to a significant difference in RPM between the engine and the second motor). The method may charge the second motor P2 with higher charging efficiency than the charging efficiency of a method in which the engine ENG charges the battery BAT through only a hybrid starter generator (HSG).

For example, the operations S121 and S122 of controlling according to the first condition may include controlling two-wheel driving through torque provided by the first motor P4. The operation S123 of controlling according to the second condition may include controlling two-wheel driving through the second motor P2 or four-wheel driving through the first and second motors P4 and P2. The operation S142 of controlling according to the third condition may include controlling two-wheel driving through the engine ENG or four-wheel driving through the engine ENG and the first motor P4.

When switching is performed from the low-speed stage (the first condition or the second condition) to the high-speed stage (the third condition) (S141), the engine ENG may be engaged with the second motor P2. When the low-speed stage (the first condition or second condition) is maintained or when the high-speed stage (the third condition) is switched to the low-speed stage (the first condition or the second condition) (S143), the engine ENG may be separated from the second motor P2.

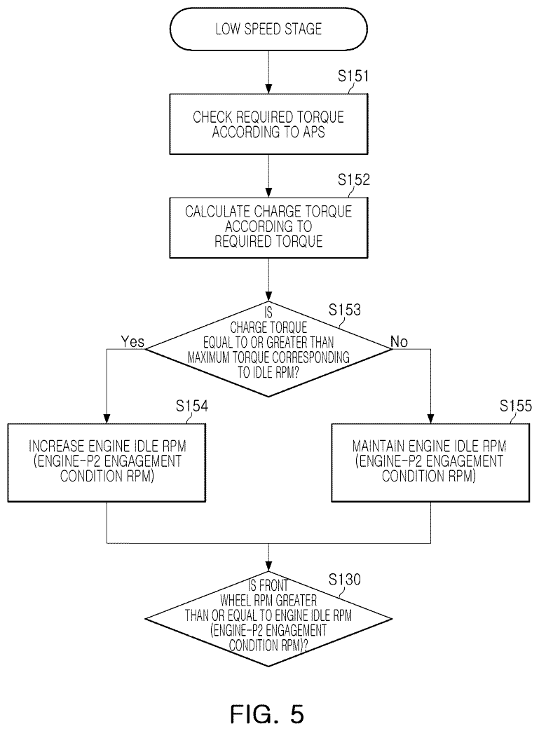

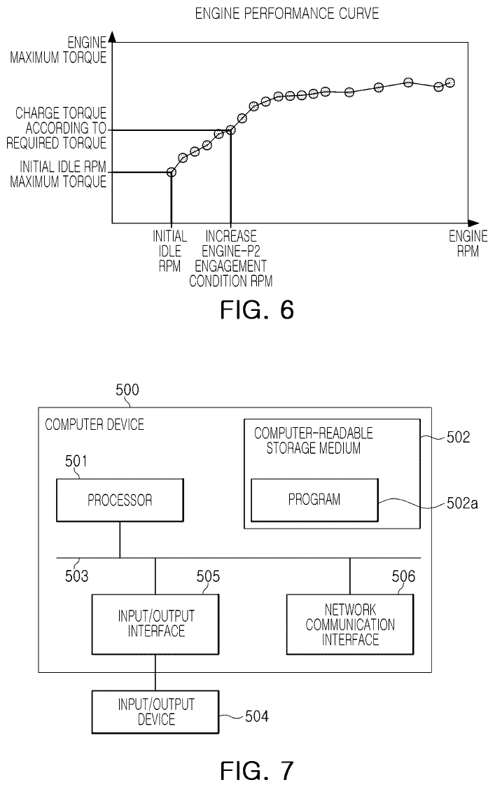

FIG. 5 is a flowchart illustrating an operation of adjusting an engagement condition revolution per minute (RPM) (or engine idle RPM) between an engine and a second motor according to an accelerator pedal sensor sensing value in a system and a method for controlling a hybrid electric vehicle according to an embodiment of the present disclosure, and FIG. 6 is an engine performance curve representing adjustment of an engagement condition RPM (or engine idle RPM) between an engine and a second motor according to an accelerator pedal sensor sensing value in a system and a method for controlling a hybrid electric vehicle according to an embodiment of the present disclosure.

Referring to FIGS. 1, 5, and 6, the controller 500 may control the engine ENG to be engaged with the second motor P2 when the RPM of the other (e.g., the front wheel) among the front wheel FW and the rear wheel RW of the hybrid electric vehicle HEV reaches an engagement condition RPM. In this case, the controller 500 may receive a sensing value (S151) from an accelerator pedal sensor (e.g., included in the sensor unit 300) and may selectively adjust the engagement condition RPM (S154, S155) according to the sensing value. For example, the engagement condition RPM may be a constant or a function (a function in which the sensing value of the accelerator pedal sensor is an input variable) corresponding to an idle RPM of the engine ENG.

For example, in the operation S142 of controlling according to the third condition of FIG. 4, the controller 500 may receive corresponding data between the sensing value and charge torque and may selectively increase the engagement condition RPM (S154 and S155) according to the relationship between the charge torque (S152) determined according to the sensing value and the corresponding data and the maximum torque (S153) corresponding to the idling of the engine ENG.

For example, the corresponding data between the sensing value and the charge torque may be designed in consideration of the charging efficiency of the second motor P2 (e.g., design according to the result of a charging efficiency experiment). The corresponding data may be provided to the controller 500 in advance (e.g., before the first use of the hybrid electric vehicle). The corresponding data may be a group of a plurality of constants (e.g., a lookup table) or a function (e.g., a function in which the charging efficiency is an input variable).

For example, when the sensing value of the accelerator pedal sensor corresponds to an opening rate of 30% (e.g., an opening rate of a throttle of the engine), the required torque may be 100 Nm (depending on the engine specifications), and the charge torque may be 110 Nm (or 110% of the required torque) based on the corresponding data between the sensing value and the charge torque.

If the charge torque is lower than or equal to the maximum torque corresponding to the idling of the engine ENG, the second motor P2 may effectively generate power at an RPM lower than or equal to the idling of the engine ENG to charge the battery BAT. When the charge torque exceeds the maximum torque corresponding to the idling of the engine ENG, the controller 500 may increase the engagement condition RPM so that the engine ENG is engaged with the second motor P2 in a state in which the RPM of the second motor P2 is higher or may increase a real-time idle RPM of the engine ENG so that the engine ENG may be controlled to be engaged with the second motor P2 at a higher RPM.

For example, in the operation S142 of controlling according to the third condition of FIG. 4, the controller 500 may control the engine ENG to be engaged with the second motor P2 when the RPM of the other (e.g., the front wheel) among the front wheel FW and the rear wheel RW of the hybrid electric vehicle HEV reaches an idle RPM of the engine ENG. In this case, the controller 500 may receive a sensing value (S151) from an accelerator pedal sensor (e.g., included in the sensor unit 300) and may selectively increase the idle RPM according to the sensing value (S154, S155).

Meanwhile, referring to FIG. 7, the controller 500 of the system for controlling the hybrid electric vehicle according to an embodiment of the present disclosure may be implemented as a computing system including at least one processor 501, a computer-readable storage medium 502, and a communication bus 503. For example, the controller 500 may be implemented as a microcontroller or an embedded system. The storage medium 502 may record one or more programs including instructions for executing a method for controlling a hybrid electric vehicle according to an embodiment of the present disclosure. The communication bus 503 may interconnect various other components of the computing device 500, including the processor 501 and the computer-readable storage medium 502.

The processor 501 may cause the controller 500 to operate according to the embodiment described above. For example, the processor 501 may execute one or more programs stored in the computer-readable storage medium 502. The one or more programs may include one or more computer-executable instructions, and the computer-executable instructions may be configured to cause the controller 500 to perform operations according to the embodiment when executed by the processor 501.

The computer-readable storage medium 502 may be configured to store computer-executable instructions or program code, program data, and/or other suitable forms of information. The program 502a stored on the computer-readable storage medium 502 includes a set of instructions executable by the processor 501. In an embodiment, the computer-readable storage medium 502 may be memory (volatile memory, such as random access memory, nonvolatile memory, or suitable combinations thereof), one or more magnetic disk storage devices, optical disk storage devices, flash memory devices, or any other form of storage medium that may be accessed by the controller 500 and capable of storing desired information, or suitable combinations thereof.

The controller 500 may also include one or more input/output interfaces 505 providing an interface for one or more input/output devices 504 and one or more network communication interfaces 506. The input/output interface 505 and the network communication interface 506 are connected to the communication bus 503. The network may be one of a cellular network, such as global system for mobile communications (GSM), enhanced data rates for GSM evolution (EDGE), general packet radio service (GPRS), code division a plurality of access (CDMA), time division-CDMA (TD-CDMA), universal mobile telecommunications system (UMTS), long term evolution (LTE), 5G, Wi-Fi, or another cellular network, and may also be implemented as Ethernet, media oriented systems transport (MOST), Flexray, controller area network (CAN), local interconnect network (LIN), Internet, Bluetooth, near field communication (NFC), Zigbee, radio frequency (RF), etc.

The input/output device 504 may be connected to other components of the controller 500 via the input/output interface 505. For example, the input/output devices 504 may include input devices, such as pointing devices (such as a mouse or trackpad), keyboards, touch input devices (such as a touchpad or a touchscreen), voice or sound input devices, various types of sensor devices and/or imaging devices, and/or output devices, such as display devices, printers, speakers, and/or network cards. For example, the input/output device 504 may be included in the controller 500 as a component constituting the controller 500, or may be connected to the controller 500 as a separate device distinct from the controller 500.

The system and the method for controlling the hybrid electric vehicle according to an embodiment of the present disclosure may stably prevent a decrease/interruption of torque providing performance of a motor due to an excessively low state of charge of a battery. The system and the method may reduce engagement shock during an engagement process between an engine and a motor (e.g., engagement shock due to a difference in revolutions per minute (RPM) between the engine and the motor). The system and the method may charge the motor with higher charging efficiency than charging efficiency of a method in which the engine charges the battery through only a hybrid starter generator.

Meanwhile, the embodiments of the present disclosure may include a program for performing the methods described in the present disclosure on a computer and a computer-readable recording medium including the program. The computer-readable recording medium may include program instructions, local data files, local data structures, etc., alone or in combination. The medium may be those specifically designed and configured for the present disclosure or may be those commonly available in the computer software field. Examples of computer-readable recording medium include magnetic medium, such as hard disks, floppy disks, and magnetic tapes, optical recording medium, such as CD-ROMs, DVDs, and hardware devices specifically configured to store and perform program instructions, such as ROM, RAM, flash memory, etc. Examples of the program may include not only machine language code, such as that generated by a compiler, but also high-level language code that may be executed by a computer using an interpreter or the like.

While example embodiments have been shown and described above, it should be apparent to those having ordinary skill in the art that modifications and variations could be made without departing from the scope of the present disclosure as defined by the appended claims.

What is claimed is:

1. A system for controlling a hybrid electric vehicle including a pair of front wheels and a pair of rear wheels, the system comprising:
a first motor configured to provide torque to one of the pair of front wheels and the pair of rear wheels of the hybrid electric vehicle;
a second motor configured to provide torque to the remaining pair of wheels, among the pair of front wheels and the pair of rear wheels, not driven by the first motor, of the hybrid electric vehicle;
an engine configured to provide torque to the remaining pair of wheels of the hybrid electric vehicle;
a battery configured to provide energy to the second motor; and
a controller configured to:
control at least one of the engine or the second motor to provide the torque to the remaining pair of wheels when a speed of the hybrid electric vehicle is greater than a predetermined speed value or a state of charge (SOC) of the battery is greater than a predetermined SOC value; and
control the first motor to provide the torque to the one of the pair of front wheels and the pair of rear wheels to charge the battery through the second motor when the speed of the hybrid electric vehicle is equal to or less than the predetermined speed value and the SOC of the battery is equal to or less than the predetermined SOC value.

2. The system of claim 1, wherein the controller is further configured to:
control the engine to provide the torque to the remaining pair of wheels when the speed of the hybrid electric vehicle is greater than the predetermined speed value; and
control the second motor to provide the torque to the remaining pair of wheels when the speed of the hybrid electric vehicle is equal to or less than the predetermined speed value and the SOC of the battery is greater than the predetermined SOC value.

3. The system of claim 2, wherein the controller is further configured to:
control two-wheel driving through the engine or four-wheel driving through the engine and the first motor when the speed of the hybrid electric vehicle is greater than the predetermined speed value.

4. The system of claim 3, wherein the controller is further configured to:
control two-wheel driving through the torque provided by the first motor when the speed of the hybrid electric vehicle is equal to or less than the predetermined speed value and the SOC of the battery is equal to or less than the predetermined SOC value; and
control two-wheel driving through the second motor or four-wheel driving through the first and second motors when the speed of the hybrid electric vehicle is equal to or less than the predetermined speed value and the SOC of the battery is greater than the predetermined SOC value.

5. The system of claim 1, wherein the controller is further configured to:
control the engine to be engaged with the second motor when the speed of the hybrid electric vehicle is greater than the predetermined speed value; and
control the engine to be separated from the second motor when the speed of the hybrid electric vehicle is equal to or less than the predetermined speed value.

6. The system of claim 5, wherein the controller is further configured to:
control the engine to be engaged with the second motor when a revolutions per minute (RPM) of the remaining pair of wheels of the hybrid electric vehicle reaches an engagement condition RPM;
receive a sensing value from an accelerator pedal sensor; and
selectively adjust the engagement condition RPM according to the sensing value.

7. The system of claim 6, wherein the controller is further configured to:
receive corresponding data between the sensing value and a charge torque; and
selectively increase the engagement condition RPM according to a relationship between the charge torque determined according to the sensing value and the corresponding data and a maximum torque corresponding to idling of the engine.

8. The system of claim 5, wherein the controller is further configured to:
control the engine to be engaged with the second motor when a revolutions per minute (RPM) of the remaining pair of wheels of the hybrid electric vehicle reaches an idle RPM of the engine;
receive a sensing value from an accelerator pedal sensor; and
selectively increase the idle RPM according to the sensing value.

9. The system of claim 1, wherein the second motor is configured to:
generate power and charge the battery according to a charge torque generated according to rotations of the front wheel and the rear wheel of the hybrid electric vehicle by the torque provided from the first motor when the speed of the hybrid electric vehicle is equal to or less than the predetermined speed value and the SOC of the battery is equal to or less than the predetermined SOC value.

10. The system of claim 1, wherein the first motor is further configured to provide torque to the rear wheel, and
wherein the second motor and the engine are further configured to provide torque to the front wheel.

11. A system for controlling a hybrid electric vehicle, the system comprising:
a first motor configured to provide torque to a rear wheel of a hybrid electric vehicle;
a second motor configured to provide torque to a front wheel of the hybrid electric vehicle;
an engine configured to provide torque to the front wheel of the hybrid electric vehicle;
a battery configured to provide energy to the second motor; and
a controller configured to:
control the hybrid electric vehicle to four-wheel driving or front-wheel driving when a speed of the hybrid electric vehicle is greater than a predetermined speed value or a state of charge (SOC) of the battery is greater than a predetermined SOC value; and
control the hybrid electric vehicle to rear-wheel driving when the speed of the hybrid electric vehicle is equal to or less than the predetermined speed value and the SOC of the battery is equal to or less than the predetermined SOC value.

12. The system of claim 11, wherein the controller is further configured to:
control the engine to be engaged with the second motor when the speed of the hybrid electric vehicle is greater than the predetermined speed value; and
control the engine to be separated from the second motor when the speed of the hybrid electric vehicle is equal to or less than the predetermined speed value.

13. The system of claim 12, wherein the controller is further configured to:
control the engine to be engaged with the second motor when a revolutions per minute (RPM) of the front wheel reaches an engagement condition RPM;
receive a sensing value from an accelerator pedal sensor; and
selectively adjust the engagement condition RPM according to the sensing value.

14. The system of claim 12, wherein the controller is further configured to:
control the engine to be engaged with the second motor when a revolutions per minute (RPM) of the front wheel reaches an idle RPM of the engine;
receive a sensing value from an accelerator pedal sensor; and
selectively increase the idle RPM according to the sensing value.

15. The system of claim 12, wherein the controller is further configured to:
control two-wheel driving through the torque provided by the first motor when the speed of the hybrid electric vehicle is equal to or less than the predetermined speed value and the SOC of the battery is equal to or less than the predetermined SOC value; and
control two-wheel driving through the second motor or four-wheel driving through the first and second motors when the speed of the hybrid electric vehicle is equal to or less than the predetermined speed value and the SOC of the battery is greater than the predetermined SOC value.

16. A method for controlling a hybrid electric vehicle including a pair of front wheels and a pair of rear wheels, the method comprising:
obtaining a speed of the hybrid electric vehicle and a state of charge (SOC) of a battery of the hybrid electric vehicle;
determining whether a plurality of conditions is satisfied;
controlling, based on a determination that a first condition among the plurality of conditions is satisfied, a first motor of the hybrid electric vehicle to provide torque to one of the pair of front wheels and the pair of rear wheels of the hybrid electric vehicle according to the first condition to charge the battery through a second motor of the hybrid electric vehicle;
controlling, based on a determination that a second condition among the plurality of conditions is satisfied, the second motor to provide torque to the remaining pair of wheels, among the pair of front wheels and the pair of rear wheels, of the hybrid electric vehicle according to the second condition; and
controlling, based on a determination that a third condition among the plurality of conditions is satisfied, an engine of the hybrid electric vehicle to provide torque to the remaining pair of wheels of the hybrid electric vehicle according to the third condition,
wherein the first condition is that the speed of the hybrid electric vehicle is equal to or less than a predetermined speed value and the SOC of the battery is equal to or less than a predetermined SOC value,
wherein the second condition is that the speed of the hybrid electric vehicle is equal to or less than the predetermined speed value and the SOC of the battery is greater than the predetermined SOC value, and
wherein the third condition is that the speed of the hybrid electric vehicle is greater than the predetermined speed value.

17. The method of claim 16,
wherein controlling according to the first condition includes controlling two-wheel driving through the torque provided by the first motor,
wherein controlling according to the second condition includes controlling two-wheel driving through the second motor or four-wheel driving through the first and second motors, and
wherein controlling according to the third condition includes controlling two-wheel driving through the engine or four-wheel driving through the engine and the first motor.

18. The method of claim 17, wherein controlling according to the third condition includes:
controlling the engine to be engaged with the second motor when a revolutions per minute (RPM) of the remaining pair of wheels of the hybrid electric vehicle reaches an engagement condition RPM;
receiving a sensing value from an accelerator pedal sensor; and
selectively adjusting the engagement condition RPM according to the sensing value.

19. The method of claim 17, wherein controlling according to the third condition includes:
controlling the engine to be engaged with the second motor when a revolutions per minute (RPM) of the remaining pair of wheels of the hybrid electric vehicle reaches an idle RPM of the engine;
receiving a sensing value from an accelerator pedal sensor; and
selectively increasing the idle RPM according to the sensing value.

20. A non-transitory storage medium for storing one or more programs including commands for executing the method of claim 16.
